(19) United States
(12) Patent Application Publication
(10) Pub. No.: US 2026/0296324 A1
(43) Pub. Date: Oct. 1, 2026

(54) TECHNOLOGY FOR EQUIPPING A UTILITY VEHICLE CAB WITH AN EQUIPMENT MODULE

(71) Applicant: MAN Truck & Bus SE, München (DE)

(72) Inventors: Sven GAEDTKE, München (DE); Stephan SCHÖNHERR, München (DE); Jan Robin McCANN, München (DE); Marius MAIER, München (DE)

(73) Assignee: MAN Truck & Bus SE, München (DE)

(21) Appl. No.: 19/481,134

(22) PCT Filed: Apr. 19, 2024
(86) PCT No.: PCT/EP2024/060764

§ 371 Date: Nov. 3, 2025

(30) Foreign Application Priority Data
May 4, 2023 (DE) 10 2023 111 605.3

(51) Int. Cl. B60R 7/04; A47C 17/80; B60N 3/00; B60R 3/02; B60R 11/02

(52) U.S. Cl. CPC B60R 7/04; A47C 17/80; B60N 3/002; B60R 3/02; B60R 11/0229

(57) ABSTRACT

The invention relates to a commercial vehicle cab with an equipment module. The invention further relates to a modular equipment kit for a commercial vehicle cab of a commercial vehicle and to a method for equipping a commercial vehicle cab. The commercial vehicle cab (1) comprises a front area (2) and a rear area (3), wherein the front area (2) comprises a driver's seat (4) and a cockpit area (5). Furthermore, the commercial vehicle cab (1) comprises an equipment module (6) arranged between the front area (2) and the rear area (3) and that is displaceable in a transverse direction (7) of the commercial vehicle cab (1). This offers the particular advantage that the equipment module (6) can be displaced, as required, into a position that is conveniently usable or that is not, or at least only slightly, disturbing. Advantageously, the interior configuration of the commercial vehicle cab can be quickly and easily adapted to different use situations simply by displacing the equipment module.

The invention relates to a commercial vehicle cab, preferably a driver's cab of a truck, having an equipment module. The invention further relates to a method for equipping a commercial vehicle cab with an equipment module, and to a modular equipment kit for a commercial vehicle cab of a commercial vehicle.

Drivers of commercial vehicles, for example of trucks, spend a great deal of time in the commercial vehicle cab (driver's cab) of the commercial vehicle, in particular during long-distance journeys. In order to support the driver during the stay in the commercial vehicle cab, commercial vehicle cabs today are typically equipped with various facilities, for example a bed and/or a folding table on the passenger side. However, the available space in the commercial vehicle cab offers only limited possibilities for designing the commercial vehicle cab in a user-friendly manner with the solutions available so far. In particular, many applications are accessible only in certain areas. For example, a folding table is often found only on the passenger side. Access to a possible sleeping bed arranged in the upper area of the commercial vehicle cab often takes place only via one of the seats. Shelves or a table between the driver's seat and the passenger seat would block the passage between the driver's seat and the passenger seat.

The invention is therefore based on the object of providing an improved technique for equipping a commercial vehicle cab, by means of which disadvantages of previous solutions can be prevented or at least reduced. In particular, it is an object of the invention to provide an equipment module for a commercial vehicle cab which restricts the available space and the freedom of movement within the commercial vehicle cab as little as possible and can be used in a multifunctional manner.

The object is achieved by the features of the independent claims. Advantageous embodiments are specified in the dependent claims and in the description.

A first general aspect of the present disclosure relates to a commercial vehicle cab. The commercial vehicle cab is preferably a driver's cab of a truck.

The commercial vehicle cab comprises, in a manner known per se, a front area and a rear area, wherein the front area comprises a driver's seat and a cockpit area. The rear area can be used as a living area, for example during breaks, and can e.g., comprise furnishing items, for example a bed.

Furthermore, the commercial vehicle cab comprises an equipment module which is arranged between the front area and the rear area and that is displaceable in a transverse direction of the commercial vehicle cab. In other words, an equipment module is arranged between the front area and the rear area, for example behind the driver's seat, which can be moved substantially horizontally perpendicular to the straight-ahead driving direction of the commercial vehicle cab.

This provides the particular advantage that the equipment module can be pushed into a position appropriate to the current usage situation. Thus, during driving, the equipment module can be pushed, for example, into a position in which the driver can conveniently reach the equipment module. If the current usage situation changes, for example in such a way that the equipment module is disturbing at this place, for example because it blocks a passage, and/or in such a way that the equipment module is to be used at another position, the equipment module can be pushed in the transverse direction of the commercial vehicle cab to another position. In this way, the equipment module can always be positioned advantageously according to requirements.

A commercial vehicle cab describes herein, for example, a driver's cab of a commercial vehicle, such as that of a truck, in which optionally the driving personnel are on the road for several days. The equipment module can be designed in many different ways preferably in order to optimally support a user in their respective task.

According to a further advantageous embodiment, the commercial vehicle cab comprises a guiding mechanism by means of which the equipment module is displaceable in the transverse direction. The guiding mechanism preferably comprises two guide rails extending in the transverse direction of the commercial vehicle cab. The use of a guiding mechanism in the form of two guide rails makes it possible to realize a space-saving and secure displacement possibility of the equipment module.

In an advantageous embodiment variant, the guide rails are each arranged at a distance from the floor and from the roof of the commercial vehicle cab. In this way, different size ratios and different structural heights of various commercial vehicle cabs can advantageously be taken into account, since the guide rails can each be arranged at a suitable height for receiving the equipment module.

According to a further advantageous embodiment variant, the commercial vehicle cab further comprises a first furnishing item and a second furnishing item, which are each arranged in the rear area of the commercial vehicle cab. At their end regions facing the front area, the furnishing items each have one of the guide rails. The rear area of the commercial vehicle cab is particularly suitable for arranging furnishing items that can be used during a non-driving operation of the commercial vehicle, for example for sleeping or for storing objects. These furnishing items can at the same time be used for receiving guide rails. In this way, the guide rails do not need to be arranged elsewhere within the commercial vehicle cab, so that the guide rails effectively take up as little as possible of the limited installation space of the commercial vehicle cab.

Preferably, the first furnishing item is a floor module comprising a storage container and/or a resting unit, which is preferably configured as a bed. The second furnishing item is preferably a ceiling module comprising a storage container and/or a resting unit (for example a bed).

In a further embodiment, the equipment module comprises an upper part, a middle part and a lower part which are detachably connectable to one another. This offers the advantage that the equipment module can be provided in different configurations in order to be able to adapt the equipment module to different structural heights of the commercial vehicle cab, different engine tunnel heights and/or different user preferences in a cost-efficient manner. Thus, different upper parts, middle parts and lower parts can be combined with one another as required. In particular, in the case of a detachable connection, parts of the equipment module can be replaced if necessary, while the remaining parts can be retained.

According to a further advantageous embodiment, the equipment module, on its side facing the front area, can comprise at least one of the following equipment elements: a table top which can be folded out towards the front area of the commercial vehicle cab, a shelf, a storage container and/or an elastic net, preferably arranged in the lower part of the equipment module, and one or more coat hooks. Such equipment elements enable a multifunctional equipment of the equipment module, which restricts the available space only comparatively little. Such equipment elements can be advantageously used in particular during driving or during breaks.

In a further embodiment, the equipment module, on its side facing the rear area of the driver's cab, can comprise at least one of the following equipment elements: a table top which can be folded out and/or pivoted, a step which can be folded out, preferably for facilitating entry into a bed arranged in an upper region of the rear area, a screen which can be folded out, and one or more coat hooks. The multifunctionality of the equipment module can thereby be further improved. The side of the equipment module facing the rear area of the driver's cab can be used in a particularly advantageous manner during the driver's breaks. Accordingly, equipment elements that are suitable for use during such breaks are particularly suitable for equipping this side of the equipment module.

According to a further embodiment, the commercial vehicle cab can further comprise a curtain attached to the equipment module. The curtain can be arranged in the transverse direction of the commercial vehicle cab between the equipment module and the commercial vehicle cab and can be spreadable and foldable by displacement of the equipment module in the transverse direction. Due to the position of the equipment module between the front area and the rear area of the commercial vehicle cab, the curtain, in the spread state, can separate the rear area from the front area and thereby enable additional privacy. The displacement mechanism of the equipment module can thus advantageously be used at the same time to indirectly spread or fold the curtain as required.

In a further embodiment, a distance along which the equipment module is displaceable in the transverse direction corresponds to more than half, more than ⅔, or more than 80% of an interior width of the commercial vehicle cab. The interior width of the commercial vehicle cab extends from the inner side of one side wall of the commercial vehicle cab to the inner side of the opposite side wall of the commercial vehicle cab. The equipment module can accordingly be displaced over a wide range of the interior width of the commercial vehicle cab. In this way, the position of the equipment module can be particularly advantageously adapted to the respective usage situation.

In a further advantageous embodiment, the equipment module can have a width in the transverse direction of the commercial vehicle cab which is smaller than 30%, more preferably smaller than 20%, of an interior width of the commercial vehicle cab. The equipment module can accordingly be configured to be narrow in comparison with the interior width of the commercial vehicle cab. In this way, the equipment module can be arranged in the commercial vehicle cab in a particularly space-saving manner. In particular, it can be easily pushed out of the way, for example in order not to block a passage within the commercial vehicle cab.

Additionally or alternatively, the equipment module can have a height which is greater than 65%, more preferably greater than 80%, of an interior height of the commercial vehicle cab. Since the equipment module is arranged displaceably in the commercial vehicle cab, the equipment module does not need to be designed in such a way that a user must be able to walk under or over the equipment module. Accordingly, the equipment module can be designed in such a way that it extends over a considerable part of the interior height of the commercial vehicle cab, so that the available space within the commercial vehicle cab can be optimally utilized.

A further aspect of the present disclosure relates to a commercial vehicle, preferably a truck, comprising a commercial vehicle cab as described herein. Particularly preferably, the commercial vehicle is a truck or a semi-trailer tractor.

A further general aspect of the present disclosure relates to a modular equipment kit for a driver's cab of a commercial vehicle (commercial vehicle cab), which has a front area and a rear area, the front area comprising a driver's seat and a cockpit area. The modular equipment kit comprises equipment modules that are arrangeable between the front area and the rear area and are displaceable in a transverse direction of the commercial vehicle cab. The modular equipment kit can comprise several equipment modules as described in this document. The modular equipment kit can be used to derive and/or produce different variants of the equipment modules, i.e. differently configured equipment modules. This enables a flexible and cost-efficient equipment of a commercial vehicle cab with a high diversity of variants.

According to a particularly advantageous embodiment, the equipment modules can each comprise an upper part, a middle part and a lower part which are connectable to one another, preferably detachably connectable to one another. The modular equipment kit can comprise several variants of the upper part, the middle part and the lower part, which are selectively combinable with one another for realizing different variants of the equipment module resulting from different combinations of an upper part, a middle part and a lower part. Accordingly, a commercial vehicle cab can be equipped in a modular and flexible manner by means of the modular equipment kit, depending on the desired equipment configuration. Retrofitting or reconfiguring of a commercial vehicle cab is thereby also possible efficiently and easily.

In a further preferred embodiment, the different variants of the upper part, the middle part and the lower part can differ in their equipment configurations and/or in their structural height. In this way, different spatial conditions of various commercial vehicle cabs can be particularly advantageously taken into account. In particular, different commercial vehicle cabs can be equipped in such a way that the available installation space is optimally utilized. Different structural heights for the lower parts are particularly advantageous in order to be able to adapt the lower part to different engine tunnel heights, which restrict the available space in the lower central area of the commercial vehicle cab to different extents.

According to a further general aspect of the present disclosure, a method for equipping a commercial vehicle cab, preferably a commercial vehicle cab as described herein, is provided. The commercial vehicle cab has a front area and a rear area. Furthermore, the commercial vehicle cab has a guiding mechanism for holding an equipment module displaceably in the transverse direction of the commercial vehicle cab.

The method comprises the step of providing a modular equipment kit as described herein. Furthermore, the method comprises the step of equipping the commercial vehicle cab with an equipment module derived from the modular equipment kit, wherein the equipment module is to be arranged displaceably in the transverse direction of the commercial vehicle cab on the guiding mechanism.

In order to avoid repetitions, features disclosed purely in terms of the device shall also be considered to be disclosed and claimable in terms of the method, and vice versa. The above-mentioned advantages, aspects and features according to the invention described in connection with the commercial vehicle cab, in particular with regard to the configuration, holding and equipment of the equipment module with various equipment elements, therefore also apply to the modular equipment kit as well as to the method for equipping a commercial vehicle cab, and vice versa.

The previously described preferred embodiments and features of the invention can be combined with one another in any desired manner. Further details and advantages of the invention are described below with reference to the accompanying figures. They show:

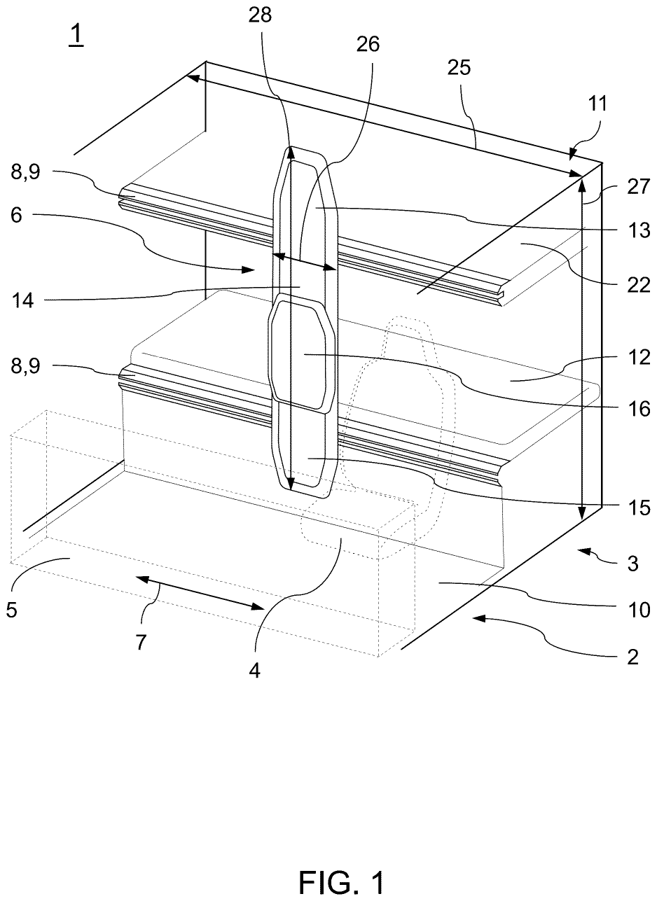

FIG. 1 a schematic representation of a commercial vehicle cab according to an embodiment of the invention;

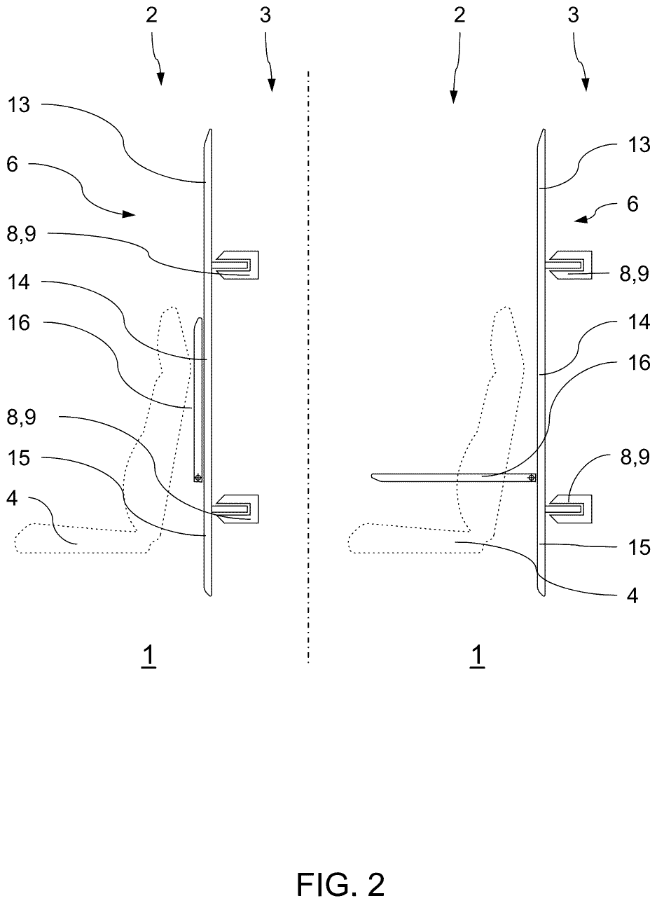

FIG. 2 a schematic representation of a commercial vehicle cab according to a further embodiment of the invention;

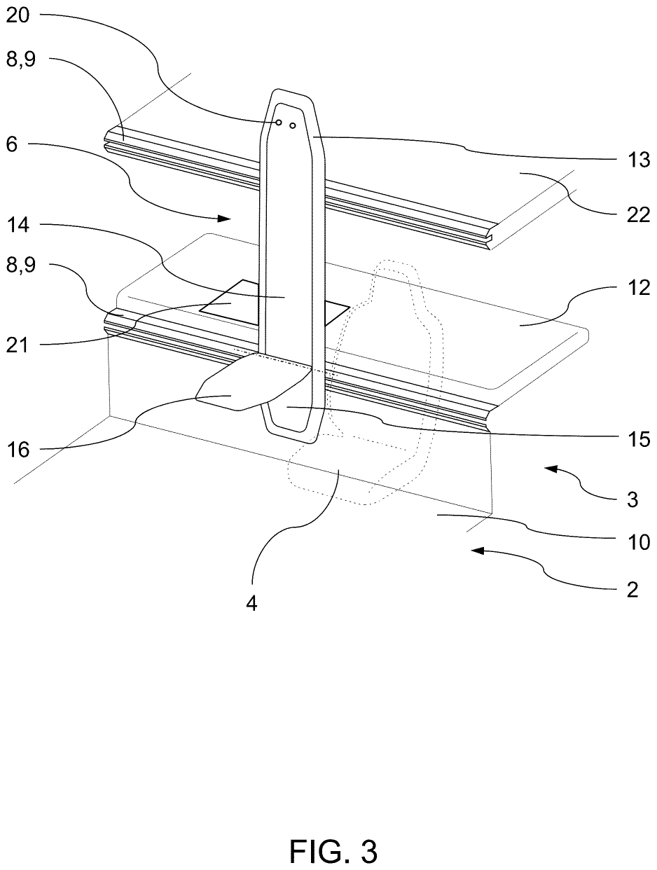

FIG. 3 a schematic representation of a commercial vehicle cab according to a further embodiment of the invention;

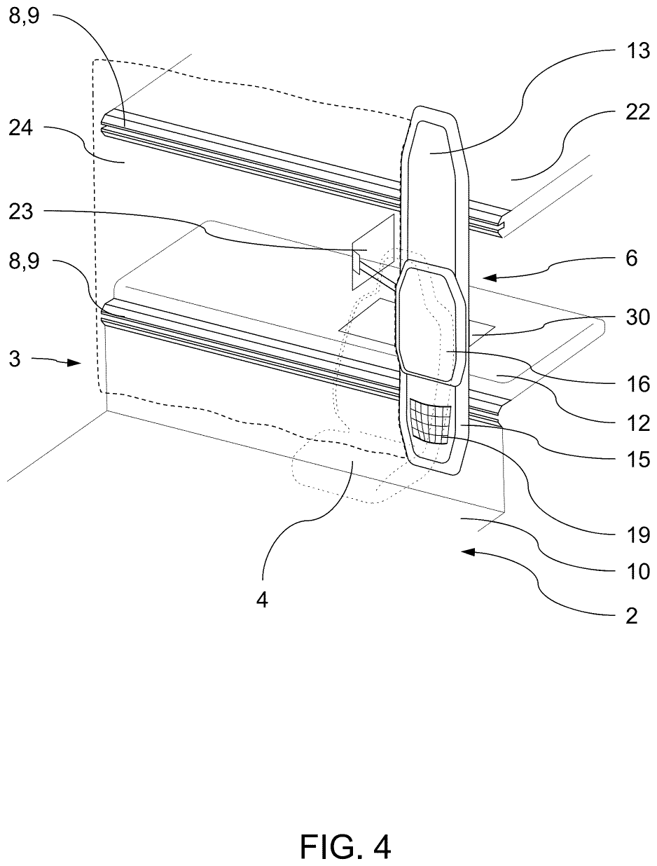

FIG. 4 a schematic representation of a commercial vehicle cab according to a further embodiment of the invention;

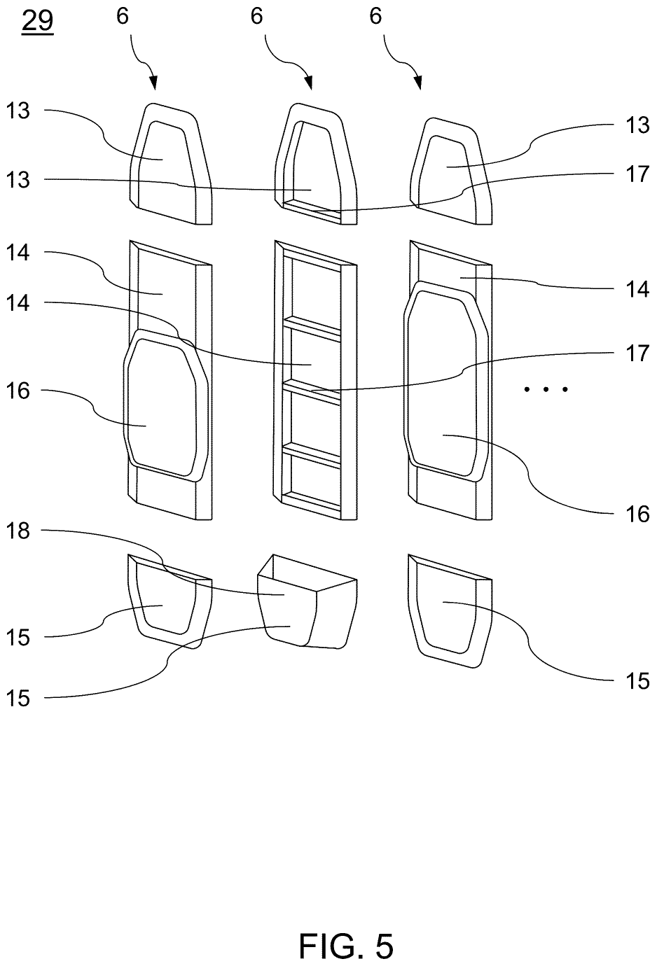

FIG. 5 a schematic representation of a modular equipment kit according to a further embodiment of the invention; and

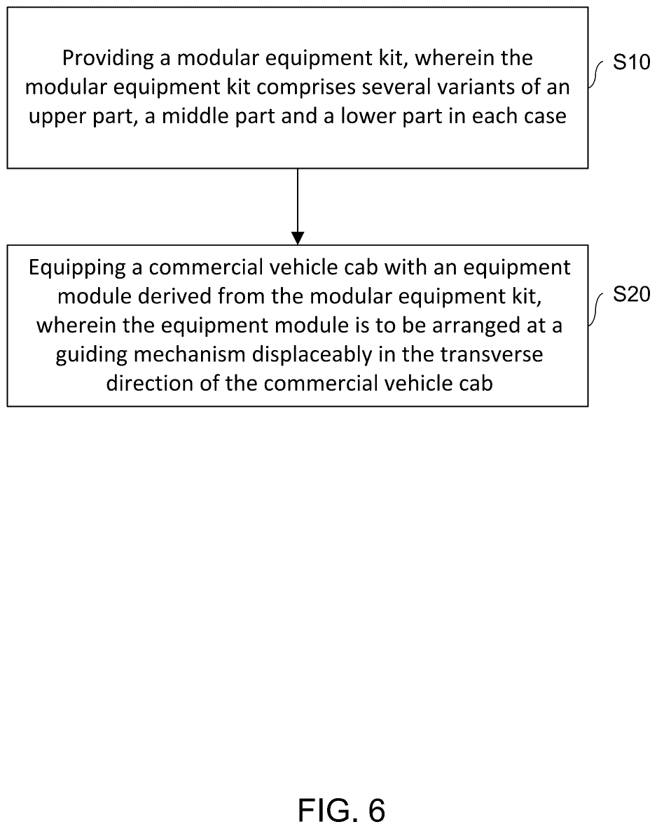

FIG. 6 a flow chart for illustrating a method for equipping a commercial vehicle cab according to a further embodiment of the invention.

The embodiments shown in the figures correspond at least in part, so that similar or identical parts are provided with the same reference signs, and reference is also made to the description of the other embodiments or figures for their explanation, in order to avoid repetitions.

FIG. 1 shows a schematic representation of a commercial vehicle cab 1. Drivers of commercial vehicles spend a great deal of time in the commercial vehicle cab 1 of the commercial vehicle, in particular during long-distance journeys. In order to optimally support the driver during the stay in the commercial vehicle cab 1, additional facilities that do not primarily serve for controlling the commercial vehicle can be arranged in the commercial vehicle cab 1.

FIG. 1 illustrates an exemplary embodiment of a technique for the corresponding equipment of a commercial vehicle cab 1. The commercial vehicle cab 1 comprises a front area 2 and a rear area 3. In the front area 2, a driver's seat 4, preferably a (not shown) passenger seat, and a cockpit area 5 are arranged. The cockpit area 5 can comprise, for example, a steering wheel, pedals for speed control, further devices relevant to vehicle control and/or a control of an infotainment system. The driver's seat 4 and the cockpit area 5 are illustrated in the example of FIG. 1 as transparent with dashed lines in a schematic manner in order not to conceal objects located behind them.

Between the front area 2 and the rear area 3, an equipment module 6 is arranged, which is held displaceably in the transverse direction 7 of the commercial vehicle cab 1. In this way, the equipment module 6 can be made accessible to different positions of the commercial vehicle cab 1 and can also be easily stowed. For this purpose, the commercial vehicle cab 1 preferably comprises a guiding mechanism 8, by means of which the equipment module 6 is displaceable in the transverse direction 7. The guiding mechanism 8 can preferably comprise two guide rails 9 extending in the transverse direction 7. In principle, all types of rails suitable for linear guidance can be considered as guide rails 9, for example construction profile struts, T-rails or C-profiles. The guide rails 9 can, as shown in FIG. 1, be configured as horizontal rails into which the equipment module 6 can be suspended. Alternatively, vertically oriented rails can also be used, on which the equipment module 6 rests from above, or into which it is suspended from below. The two guide rails 9 can be configured identically or differently. The guide rails 9 can be positioned such that they are arranged at a distance both from the floor 10 of the commercial vehicle cab 1 and from the roof 11 of the commercial vehicle cab 1. In this way, similar equipment modules 6 can be installed in commercial vehicle cabs 1 with different interior heights 27. In particular, equipment modules 6 can be held largely independently of a specific engine tunnel height or a geometric shape of the roof 11 of the commercial vehicle cab 1.

In the rear area 3 of the commercial vehicle cab 1, at least two furnishing items 12 can preferably be arranged. The first furnishing item 12 is preferably a floor module, which can be configured, for example, as a bed or as a storage module. The second furnishing item 12 is preferably a ceiling module, which likewise preferably comprises a storage container and/or can be configured as a bed 22. Particularly preferably, the guide rails 9 are arranged at the respective end regions of the furnishing items 12 facing the front area 2. In this way, no additional holding structures for supporting the guiding mechanism 8 need to be installed in the limited usable volume of the commercial vehicle cab 1.

The equipment module 6 can comprise various equipment elements that can support the driver during driving and/or during standstill periods of the commercial vehicle. Thus, the equipment module 6 of FIG. 1 comprises, on the side facing the front area 2, by way of example, a fold-out table top 16. The driver can displace the equipment module 6 into the central area of the commercial vehicle cab 1, for example if they wish to reach it from the driver's seat 4. For example, they can fold out the table top 16 in order to use it as a shelf during a break. Preferably, the table top 16 can be shaped in such a way that, in the folded-out state, it does not hinder the driver even during driving, so that it can also be used as a shelf while driving.

If, for example, the driver wishes to enter the rear area 3 of the commercial vehicle cab, the equipment module 6 can be pushed sideways along the guide rails 9, for example behind the driver's seat 4, so that a passage between the driver's seat 4 and a (not shown) passenger seat located next to the driver's seat 4 is not blocked by the equipment module 6. The distance along which the equipment module 6 can be displaced in the transverse direction 7 preferably corresponds to more than half, more than ⅔ or more than 80% of the total interior width 25 of the commercial vehicle cab 1. Preferably, at least one of the guide rails 9 and/or the equipment module 6 comprises a (not shown) locking mechanism by means of which the equipment module 6 can be secured against unintentional displacement.

Preferably, the equipment module 6 is shaped such that it has a width 26 which is smaller than 30%, further preferably 20%, of the interior width 25 of the commercial vehicle cab 1. Additionally or alternatively, it can be shaped such that it has a height 28 which is greater than 65%, further preferably greater than 80%, of the interior height 27 of the commercial vehicle cab 1.

The equipment module 6 can comprise an upper part 13, a middle part 14 and a lower part 15, which can each be detachably connected to one another. The individual parts can preferably be assembled from a modular equipment kit comprising several variants of the upper part 13, the middle part 14 and the lower part 15. Accordingly, the commercial vehicle cab 1 can be equipped in a modular and flexible manner depending on the desired equipment configuration. Retrofitting or reconfiguring of the commercial vehicle cab 1 is also possible efficiently and easily.

FIG. 2 shows a further schematic representation of a commercial vehicle cab 1 in two different usage situations. On the left, essentially the configuration of the equipment module 6 can be seen as already shown in FIG. 1. The viewing direction of the representation in FIG. 2 is from a lateral perspective. The driver's seat 4 located in the foreground is again illustrated as transparent with dashed lines in order not to conceal the equipment module 6 located behind it.

The lateral representation of FIG. 2 illustrates the arrangement of the equipment module 6 between the front area 2 and the rear area 3 of the commercial vehicle cab 1. It can also be seen that the equipment module 6 can advantageously be designed such that, when the table top 16 is folded in, it fits completely behind the driver's seat 4 and can thus be stowed behind the driver's seat 4 without the driver having to take any elaborate action.

The right side of FIG. 2 shows a representation of the equipment module 6 in which the table top 16 is folded out in the direction of the front area 2 of the commercial vehicle cab 1. The table top 16 can be designed such that it can be conveniently used from the driver's seat 4. In particular, the equipment module 6, and especially the middle part 14 of the equipment module 6, can be designed such that the table top 16 is mounted at an ergonomically reasonable height, independent of the respective position of the roof or the floor of the commercial vehicle cab 1, or of an engine tunnel located beneath it. Preferably, the table top 16 can be held at the equipment module 6 in a height-adjustable manner, so that ergonomic use of the table top 16 by persons of different body heights is possible.

FIG. 3 shows a further schematic representation of an equipment module 6. The configuration of the equipment module 6 likewise essentially corresponds to the configuration as shown in FIG. 1. In addition, the equipment module 6 preferably comprises, on the side facing the rear area 3, a step 21 by means of which, for example, a bed 22 in the upper area of the commercial vehicle cab can be reached. The step 21 can preferably be folded out as required by means of a folding or pivoting mechanism. The mechanism can be designed such that it is strong enough to support the weight of a user when stepping onto the step 21. Additionally or alternatively, the step 21 can be designed such that it can at least partially rest on a furnishing item 12 located beneath it.

Additionally or alternatively, the equipment module 6 preferably comprises at least one coat hook 20. In the example shown, two coat hooks 20 are illustrated on the side of the equipment module 6 facing the front area 2, on the upper part 13 of the equipment module 6. A different number, a different arrangement on another part 14, 15 of the equipment module 6 and/or on the side facing the rear area 3 is likewise additionally or alternatively possible.

FIG. 4 shows a further schematic representation of an equipment module 6. The configuration of the equipment module 6 is again essentially based on the configuration as shown in FIG. 1. In the example of FIG. 4, the equipment module 6 has been displaced behind the driver's seat 4 by means of the guiding mechanism 8. On the side facing the front area 2, an elastic net 19 is arranged on the lower part 15, which can be used, for example, for storing objects. The elastic net 19 can be made of an elastic material, e.g. rubber cords, and/or of non-elastic cords or bands. The individual meshes of the elastic net 19 can be completely open or covered on the inner or outer side by a preferably elastic fabric and/or mesh material. Additionally or alternatively, the elastic net 19 and/or further elastic nets can be arranged at other positions of the equipment module 6.

On the side facing the rear area 3, for example on the middle part 14, a table top 30 and/or a screen 23 can be arranged, which are each arranged at the equipment module 6 so as to be foldable and/or pivotable. The folding or pivoting mechanism can be designed such that the table top 30 and/or the screen 23 are adjustable in their position. For this purpose, for example, jointed arms, flexible holding tubes (“goosenecks”) and/or telescopic rails can be used. In addition, the position of the screen 23 and/or the table top 30 can be changed by displacing the equipment module 6 itself.

Furthermore, a curtain 24 can be arranged at the equipment module 6, which can be connected, for example, on one side to the equipment module 6 and on the other side to a wall of the commercial vehicle cab, so that, for example, additional privacy and/or darkening of the rear area 3 can be achieved. The connection between the curtain 24 and the wall or the equipment module 6 can extend along the entire adjacent edge of the curtain 24 or only along a partial section thereof, for example at the respective upper corner. The curtain 24 can form a substantially rectangular surface or can, for example, have a passage in the middle area so that easy passage is made possible. The connection between the curtain 24 and the wall and/or between the curtain 24 and the equipment module 6 preferably comprises a stowing mechanism for the curtain 24, for example in the form of a winding cassette. The curtain 24 can be made, for example, of a fully flexible fabric material or a partially stable material such as a rollable canvas material. Alternatively, the curtain 24 can be designed to be foldable, i.e., the curtain 24 is folded together, preferably automatically folded together, when the equipment module 6 is displaced towards the wall on which the curtain 24 is connected to the commercial vehicle cab.

FIG. 5 illustrates a modular equipment kit 29 for a driver's cab of a commercial vehicle (commercial vehicle cab). The modular equipment kit 29 comprises equipment modules 6, as described, for example, in FIGS. 1 to 4, and which are arrangeable between a front area and a rear area of the commercial vehicle cab and are displaceable in a transverse direction of the commercial vehicle cab. The modular equipment kit 29 is preferably designed such that the equipment modules 6 resulting therefrom each comprise an upper part 13, a middle part 14 and a lower part 15, which can preferably each be detachably connected to one another. The modular equipment kit 29 can comprise several variants of the upper part 13, the middle part 14 and the lower part 15, so that different variants of the equipment module 6 can be realized from a combination thereof. The different variants of the upper part 13, the middle part 14 and the lower part 15 can differ in their equipment configurations and/or in their structural height.

FIG. 5 shows, for illustration, three different embodiment variants of an upper part 13, a middle part 14 and a lower part 15, respectively, which are each shown combined into an equipment module 6 and arranged one above the other. The equipment module 6 shown on the left again corresponds to the configuration of FIG. 1, wherein the middle part 14 comprises a fold-out table top 16.

The middle equipment module 6 is equipped at the upper part 13 and at the middle part 14 with several shelves 17. The lower part 15 comprises a storage container 18.

The equipment module 6 on the right side has a basically similar configuration as the equipment module 6 shown on the far left; however, the table top 16 is enlarged compared to the left configuration, and the size ratios of the individual module parts 13, 14, 15 are each changed. In this way, it is possible, for example, to take into account different spatial conditions in the commercial vehicle cab and/or different engine tunnel heights. In the example of FIG. 5, all equipment modules 6 are shown combined from an upper part 13, a middle part 14 and a lower part 15 such that they all have an essentially identical overall height. However, this does not necessarily have to be the case.

The upper parts 13, middle parts 14 and lower parts 15 shown in FIG. 5, as well as their combination into equipment modules 6, are to be understood merely as exemplary embodiments, which is indicated in FIG. 5 by three dots on the right side indicating continuation. Furthermore, the individual parts 13, 14, 15 do not have to be limited to only one function per part 13, 14, 15. For example, it would be possible that on the middle part 14 of the middle equipment module 6 an additional fold-out table top 16, comparable to those of the other two middle parts 14, can be arranged, and/or that some of the compartments formed by the shelves 17 could be replaced by closable storage containers 18. In particular, any upper parts 13, middle parts 14 and lower parts 15 can be combined with one another in order to represent different functions depending on the equipment. Overall, the modular equipment kit 29 thereby enables a demand-oriented equipment of different types of commercial vehicle cabs, even under significantly differing spatial conditions and, for example, technically caused spatial restrictions.

FIG. 6 shows a flow chart for illustrating a method for equipping a commercial vehicle cab according to a further embodiment of the invention. The commercial vehicle cab preferably corresponds to a commercial vehicle cab as described above. In particular, the commercial vehicle cab comprises a front area and a rear area. Furthermore, the commercial vehicle cab comprises a guiding mechanism for holding an equipment module displaceably in the transverse direction of the commercial vehicle cab.

For carrying out the method, in step S10, a modular equipment kit as described above is provided. The modular equipment kit comprises several variants of an upper part, a middle part and a lower part in each case. Subsequently, step S20 follows, the equipping of the commercial vehicle cab with an equipment module derived from the modular equipment kit. The equipment module is to be arranged at the guiding mechanism displaceably in the transverse direction of the commercial vehicle cab.

An equipment of a commercial vehicle cab with such a guiding mechanism as well as with an equipment module that has been configured from the modular equipment kit can take place already during the manufacture of the commercial vehicle cab or also in the course of a later retrofitting. In addition, in the course of a later retrofitting, already existing equipment modules or also individual upper parts, middle parts and/or lower parts can be replaced by others in each case, preferably in order to extend or improve the usability for a driver.

Although the invention has been described with reference to certain embodiments, it is apparent to a person skilled in the art that various changes can be made and equivalents can be used as a substitute without departing from the scope of the invention. Consequently, the invention is not intended to be limited to the disclosed embodiments, but is intended to include all embodiments that fall within the scope of the appended patent claims. In particular, the invention also claims protection for the subject matter and the features of the dependent claims independently of the claims referred to.

### LIST OF REFERENCE SIGNS

1 commercial vehicle cab
2 front area
3 rear area
4 driver's seat
5 cockpit area
6 equipment module
7 transverse direction of the commercial vehicle cab
8 guiding mechanism
9 guide rail
10 floor of the commercial vehicle cab
11 roof of the commercial vehicle cab
12 furnishing item
13 upper part
14 middle part
15 lower part
16 table top in the front area
17 shelf
18 storage container
19 elastic net
20 coat hook
21 step
22 bed
23 screen
24 curtain
25 interior width of the commercial vehicle cab
26 width of the equipment module
27 interior height of the commercial vehicle cab
28 height of the equipment module
29 modular equipment kit 30 table top in the rear area

1-15. (canceled)

16. A commercial vehicle cab comprising:
a front area and a rear area, wherein the front area comprises a driver's seat and a cockpit area, and
an equipment module arranged between the front area and the rear area and displaceable in a transverse direction of the commercial vehicle cab.

17. The commercial vehicle cab according to claim 16, comprising a guiding mechanism by means of which the equipment module is displaceable in the transverse direction, the guiding mechanism comprising two guide rails extending in the transverse direction of the commercial vehicle cab.

18. The commercial vehicle cab according to claim 17, wherein the guide rails are each arranged at a distance from a floor and from a roof of the commercial vehicle cab.

19. The commercial vehicle cab according to claim 17, further comprising a first furnishing item and a second furnishing item, each arranged in the rear area of the commercial vehicle cab, each of the furnishing items having, at its end region facing the front area, one of the guide rails.

20. The commercial vehicle cab according to claim 16, wherein the equipment module comprises an upper part, a middle part, and a lower part which are detachably connectable to one another.

21. The commercial vehicle cab according to claim 16, wherein the equipment module, on a side facing the front area, comprises at least one of the following equipment elements: a table top which can be folded out towards the front area of the commercial vehicle cab, a shelf, a storage container or an elastic net, and one or more coat hooks.

22. The commercial vehicle cab according to claim 16, wherein the equipment module, on a side facing the rear area, comprises at least one of the following equipment elements: a table top which can be folded out or pivoted, a step which can be folded out, a screen which can be folded out, and one or more coat hooks.

23. The commercial vehicle cab according to claim 16, further comprising a curtain attached to the equipment module, which is arranged between the equipment module and the commercial vehicle cab in the transverse direction of the commercial vehicle cab, the curtain being spreadable and foldable by displacement of the equipment module in the transverse direction.

24. The commercial vehicle cab according to claim 16, wherein a distance along which the equipment module is displaceable in the transverse direction corresponds to more than half, more than two-thirds, or more than eighty percent of an interior width of the commercial vehicle cab.

25. The commercial vehicle cab according to claim 16, wherein the equipment module
a) has a width in the transverse direction of the commercial vehicle cab which is smaller than thirty percent of an interior width of the commercial vehicle cab; or
b) has a height which is greater than sixty-five percent of an interior height of the commercial vehicle cab.

26. A commercial vehicle comprising a commercial vehicle cab according to claim 16.

27. A modular equipment kit for a driver's cab of a commercial vehicle having a front area and a rear area, the front area comprising a driver's seat and a cockpit area, wherein the modular equipment kit comprises equipment modules that are arrangeable between the front area and the rear area and displaceable in a transverse direction of the commercial vehicle cab.

28. The modular equipment kit according to claim 27, wherein the equipment modules each comprise an upper part, a middle part, and a lower part which are detachably connectable to one another, and wherein the modular equipment kit comprises several variants of the upper part, the middle part, or the lower part, which are selectively combinable with one another for realizing different variants of the equipment module resulting from different combinations of an upper part, a middle part, and a lower part.

29. The modular equipment kit according to claim 27, wherein the different variants of the upper part, the middle part, and the lower part differ in their equipment configurations or in their structural height.

30. A method for equipping a commercial vehicle cab having a front area and a rear area and a guiding mechanism for holding an equipment module displaceably in the transverse direction of the commercial vehicle cab, wherein the method comprises:
providing a modular equipment kit according to claim 27; and
equipping the commercial vehicle cab with an equipment module derived from the modular equipment kit, wherein the equipment module is arranged displaceably in the transverse direction of the commercial vehicle cab on the guiding mechanism.

31. The commercial vehicle cab according to claim 16, wherein the commercial vehicle cab is a driver's cab of a truck.

32. The commercial vehicle cab according to claim 21, wherein the storage container or the elastic net is arranged in the lower part of the equipment module.

33. The commercial vehicle cab according to claim 22, wherein the step can be folded out for facilitating entry into a bed arranged in an upper region of the rear area.

34. The commercial vehicle cab according to claim 25, wherein:
a) the width in the transverse direction of the commercial vehicle cab is smaller than twenty percent of the interior width of the commercial vehicle cab; or
b) the height is greater than eighty percent of the interior height of the commercial vehicle cab.

35. The commercial vehicle of claim 26, wherein the commercial vehicle is a truck.
